(19) United States
(12) Patent Application Publication
(10) Pub. No.: US 2019/0076761 A1
(43) Pub. Date: Mar. 14, 2019

(54) FILTER ASSEMBLY AND WIPER THEREFOR AND METHOD OF MAKING SAME

(71) Applicant: Eaton Intelligent Power Limited, Dublin (IE)

(72) Inventor: Christopher Scott RAU, Battle Creek, MI (US)

(73) Assignee: Eaton Intelligent Power Limited, Dublin (IE)

(21) Appl. No.: 15/700,244

(22) Filed: Sep. 11, 2017

(51) Int. Cl. B01D 35/16

(52) U.S. Cl. CPC B01D 35/16

(57) ABSTRACT

A filter assembly is provided for filtering pressurized fluid having a pressure vessel with an inlet, outlet and annular filter media for filtering fluid flow from inlet to outlet. An integrally molded one piece member wiper piston having an integral one piece hub, spoke-like radial springs and arcuate wiper segments attached to each spring is slidably disposed in the annular filter and is connected to an operating rod. A servo actuator effects movement of the rod and wiper for cleaning contaminants from the upstream side of the filter media. The one piece wiper member is readily and easily removed from the operating rod for replacement.

### BACKGROUND

The present disclosure relates to fluid filtration and in particular, filter assemblies employed in filtering fluids in single-pass and multipass systems and fluids employed for use where contaminants in the fluid cannot be tolerated. Fluid filtering systems for such purposes typically operate by receiving fluid under pressure, as for example fluid provided by a pump, and are typically connected through suitable conduits to the pump outlet and receive the fluid into a pressure vessel containing suitable filter media operative for extracting contaminants and discharging the filtered fluid to an outlet of the pressure vessel. The pressure vessel is typically provided with a removable lid for facilitating service of the filtration system components. Filters having this arrangement are typically used in industrial processes where fluid products are produced which require removal of contaminants for quality purposes; as well as applications where fluid requiring filtration is recirculated through a system requiring pressurized fluid; and, thus contaminants in the fluid must be removed in order that the process system components will not be affected or damaged by contaminants and will have the desired service life without the need to periodically stop the process and drain and replace the fluid.

In aforesaid fluid filter systems that incorporate a permanent filtration media element, it has been the practice to provide a way or means of periodically removing the trapped contaminants on the upstream side of the filtering media in order to prevent plugging of the filter media and to prevent an increased pressure drop across the filtering media. One practice utilized to regenerate a clean state in permanent filter media is the use of a mechanical wiper that periodically sweeps collected solids from the upstream face of the filter element. In this practice, the flow of fluid through the filter is uninterrupted by this self-cleaning process. Removed solids are collected in a sump in the pressure vessel and periodically removed through the opening of a purge valve, typically discharging to an atmospheric tank or drain. In order to assure removal of the contaminants during backwashing, one or more wipers have been provided, movable and sliding tangentially along the upstream side of the filter media. Heretofore, the wiper has been connected to an operating linear actuator member such as a piston and piston rod which is selectively movable by a remotely operated actuator connected to a portion of the rod extending through a sealed outlet in the pressure vessel. Other mechanisms such as threaded drive screws may provide the same translating motion to the wiper.

In providing such a wiper for the filtering media, it has been necessary to provide one or more separate wiper blades on a piston connected to the piston rod and to provide spring biasing of the wiper blades against the upstream side of the filtering media. In prior systems, employing an annular filtering membrane as the filtering media, arcuately configured individual wiper blades have been attached to a central mounting plate in radially sliding engagement with the blades arranged in a circumferential array about the piston. In such an arrangement, separate biasing springs have been required to urge each of the arcuately configured wiper segment blades in a radially outward direction to maintain the wiping function against the annular filtering media.

Referring to FIG. 4, a wiper blade assembly for cleaning the interior of an annular filter is indicated generally at 1 and includes a central annular mounting plate 2 with an annular array of arcuately configured wiper blades 3, each of which has an annular groove 4 which permits the wiper blade 3 to be received over the mounting plate 2 in radial sliding engagement. Each of the wiper blades 3 has a spring 5 disposed between the wiper blade and the plate with one reaction end of the spring engaging the interior of the groove 4; and, the end of the spring opposite the end of the spring engaging the wiper blade is received over a lug 6 provided on the mounting plate for each of the springs 5. The mounting plate 2 has a retaining pin 7 provided thereon for each of the wiper blades 3; and, the pins 7 each are engaged in snap-over engagement with a slot 8 provided in the wiper blade for retaining the blade on the mounting plate against the biasing force of the spring 5. However, it will be understood that the slot 8 enables radially inward movement of the wiper blade 3 with respect to the central mounting plate 2. The arrangement of FIG. 4 thus requires providing separate pieces for the wiper blades and springs for replacement of the assembly 1.

In service, when replacement of the wiper blades in the aforementioned system is required, it has been necessary to remove the piston and operating rod and disassemble the wipers individually from the mounting plate and reassemble them thereon including placement of the individual bias springs and mechanical fastening of the arcuately configured wiper blades over the retaining pins onto the central mounting plate. This arrangement has required supplying for replacement a plurality of individual parts and has required a significant amount of labor to disassemble and reassemble the wiper arrangement. Accordingly, it has been desired to provide a simpler and less costly arrangement for wiping the upstream face of an annular filtering media in the aforementioned type of fluid filtration systems.

### BRIEF DESCRIPTION

The present disclosure addresses the above-described problem and provides a unique one-piece integrally formed wiper for wiping the interior or upstream surface of an annular filtering media element employed for filtering fluid in a pressurized fluid system. The wiper described in the present disclosure is adapted to be readily and easily attached or removed from an operating piston rod employed in the filtration unit for being moved along the upstream surface of the annular filtering media for removing trapped contaminants therefrom and flushing of the contaminants to a drain outlet provided in the pressure vessel containing the annular filtering media.

The wiper of the present disclosure is formed integrally with a central annular hub having a plurality of circumferentially spaced spoke-like curved or non-linear radial springs formed integrally with the hub and extending radially outwardly therefrom. Each of the spoke-like radial springs has integrally formed at the radially outer end thereof an arcuately configured wiper. The ends of each arcuate wiper are angled in a manner to provide a degree of overlap between consecutive wipers, allowing for 100% coverage of the diameter surface of the filter element to be cleaned. These arcuate wipers form an annular array of circumferentially closely spaced arcuate wipers. Thus, the hub, radial spoke-like springs, and arcuate wiper elements may be integrally formed as a one-piece member. In the present practice, the one-piece wiper, hub, and spring member may be molded of polymeric material such as, for example, polyoxymethylene, polyacetal, or polyformaldehyde material, or other suitable resilient polymeric materials.

The wiper of the present disclosure thus permits a replacement for the wipers in a fluid filtration system which requires handling of only a single member or element which is easily and readily removed and replaced from the operating piston rod in the filtration unit.

### BRIEF DESCRIPTION OF THE DRAWINGS

FIG. 1 is a cross section of a pressurized fluid filtration assembly employing an annular filter media arrangement;

FIG. 2 is a perspective view of the filter wiper of the present disclosure;

FIG. 3 is a bottom view of the wiper of FIG. 2; and

FIG. 4 is an exploded view of a prior art wiper assembly.

### DETAILED DESCRIPTION

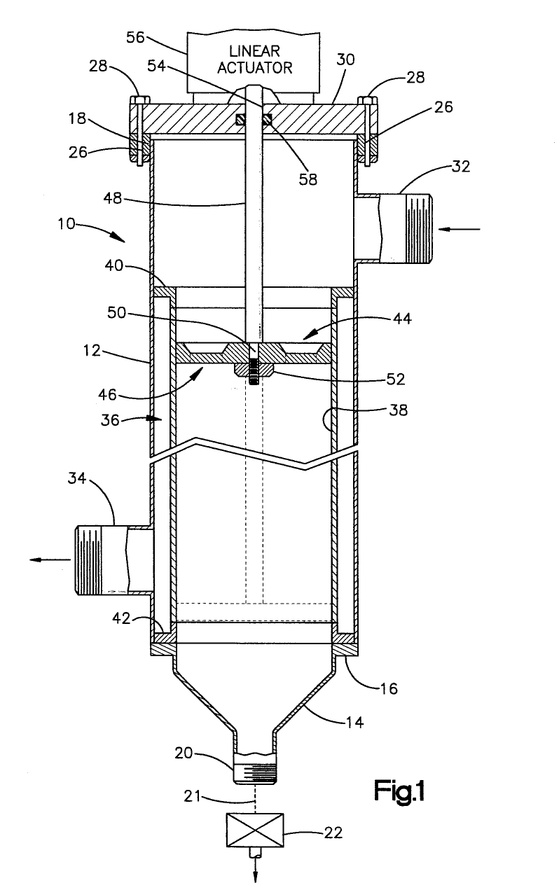

Referring to FIG. 1, a fluid filtration unit is indicated generally at 10 and has a generally cylindrical tubular pressure vessel 12 with the axis thereof disposed generally vertically with the lower end thereof closed by a shell 14 secured to the lower end of the pressure vessel 12. In the present practice, the shell 14 has an inverted generally conical configuration; and, may be secured to the pressure vessel shell 12 by suitable fluid pressure sealing arrangements such as weldment. The shell 14 has at the apex thereof a drain fitting 20 which is connected by a suitable conduit, shown in dashed line 21, to a selectively openable drain valve 22 which may be remotely actuated.

The upper end of the pressure vessel 12 is open and has an annular flange 18 provided thereabout and secured thereon by suitable means as, for example, weldment. The flange 18 has a plurality of circumferentially spaced apertures 26 formed therein which each have received therethrough fasteners such as bolts 28 for securing thereon a removable lid or closure 30. A gasket or resilient seal ring not shown in FIG. 1 is also used to prevent fluid leakage between the shell flange 18 and lid 30.

The pressure vessel 12 has an inlet fitting 32 provided adjacent the upper end thereof and an outlet fitting 34 provided adjacent the lower end thereof, each of which fittings 32, 34 communicate fluidically with the interior of the pressure vessel and is adapted for connection to a fluid pressure line for providing flow of filtered fluid from the inlet 32 to the outlet 34.

An annular filter media assembly indicated generally at 36 is received in the pressure vessel and includes an annular filter media element 38 which has secured thereto an annular flange 40 at its upper end, and an annular flange 42 attached thereto at its lower end. Flanges 40, 42 are adapted to closely inter-fit and seal against the inner periphery of the pressure vessel 12 for preventing flow therearound. In the present practice, the flanges 40, 42 may each have a resilient seal ring provided thereon for sealing thereabout between the flange and the inner periphery of the pressure vessel, which seal rings are not shown in FIG. 1. A spacer element or retainer not shown in FIG. 1 may also be employed to prevent the annular filter media assembly from moving vertically within the pressure vessel shell as it is subjected to the forces from the wiper assembly.

A wiper assembly indicated generally at 44 is disposed within the filter media 38 and includes a combination wiper piston element or member 46, which will hereinafter be described in greater detail and which is attached to an operating or piston rod 48 by having a reduced diameter portion 50 which is received through the center of the member 46 and is secured thereon by a suitable fastening means as, for example, a self-locking nut 52 threaded thereon. The operating rod extends upwardly through an aperture 54 provided centrally in the lid 30 and is connected to a selectively activated linear actuator 56, which may be remotely actuated if desired, for providing sliding movement in a vertical direction for effecting movement of the wiper indicated generally at 44. The extent of travel range of the linear actuator 56 is such as to allow the wiper assembly 44 to translate across the entire length of filter media 38. Examples of such linear actuators are shown in U.S. Pat. Nos. 7,093,721 and 9,415,339.

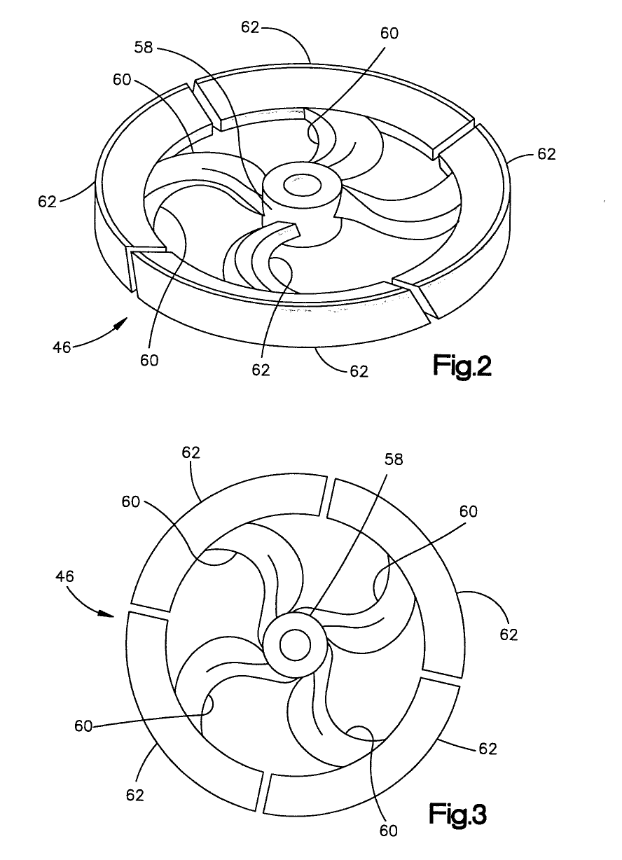

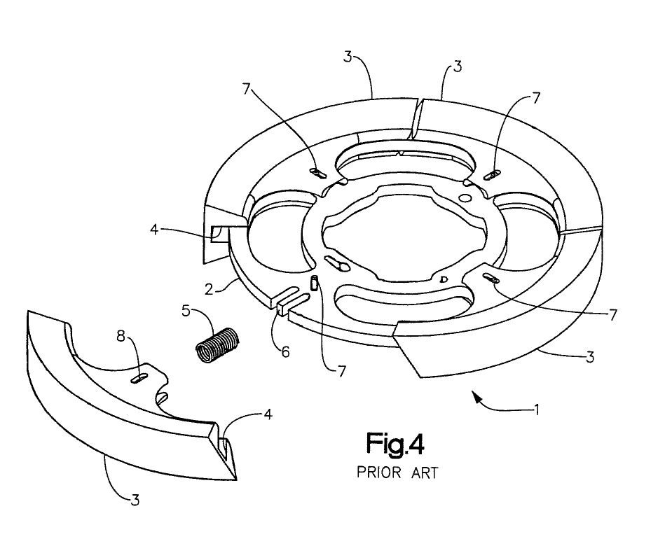

Referring to FIGS. 2 and 3, the combination wiper piston assembly 46 includes an annular hub 58 having integrally formed therewith an extending in a generally radial direction outwardly therefrom a plurality of circumferentially spaced spoke-like springs having one of a (i) curved and (ii) non-linear configuration; and, each is denoted by reference numeral 60. Each of the springs 60 has formed integrally therewith, at the radially outer ends thereof, an arcuately configured wiper segment which segments form an annular array of closely spaced wipers 62. In the present practice, the hub, springs 60, and wiper elements 62 are formed integrally as for example, by molding as a one piece member; and, it has been found satisfactory to form the one piece member 46 of polymeric material from one of (i) polyoxymethylene, (ii) polyacetal and (iii) polyformaldehyde. However, other suitable polymeric materials may be employed provided they provide the stability for the wiper function and spring function of the spring elements 60 in a radial direction. In this regard, it will be understood that the outer periphery of the array of wiper elements is formed to have at least an interference fit with the inner periphery of the filter media 38 so as to require some compression in a radially inward direction in order to insert the member 46 into the filter element 36. When assembled into the filter 36, the spring members 60 provide a bias force maintaining the outer periphery of the wiper elements 62 in contact with the inner periphery of the filter media 38. The ends of each arcuate wiper elements 62 are angled in a manner to provide a degree of overlap between adjacent wipers, preventing a straight vertical gap in coverage of the wipers on the inner diameter of the filter media 38. In the present practice, the one piece member 46 has an aggregate open area between the spoke-like springs 60 for passage of unfiltered fluid having an area of at least the area encircled by the inner periphery of annular filter less the area of the elements of the one piece member for preventing a pressure drop across the one piece wiper.

In operation, upon selected actuation, which may be accomplished remotely, the linear actuator 56 is operative to effect vertical movement of the operating rod 48 between the position shown in solid outline in FIG. 1 and the position indicated in dashed outline therein. This movement of the wiper 46 dislodges contaminants retained on the inner periphery filter media 38. The combined actions of gravity, fluid flow direction and wiping action accumulate dislodged solids into the sump of shell 14. This permits the periodic flushing of the contaminants outwardly through the drain fitting 20 upon opening of the valve 22.

The filter assembly of the present disclosure thus provides an annular fluid filter element having a wiper piston disposed therein for selective movement to remove contaminants retained upon the filter. The wiper piston is integrally molded, as a one piece member, having a hub, radially outwardly extending spring members, and an array of a plurality of circumferentially closely spaced arcuately configured wiper elements thereon which are biased into contact with the inner periphery of the annular filter element. The wiper piston of the present disclosure thus is a readily and easily removable and replaceable element for servicing the filtration assembly.

The exemplary embodiment has been described and illustrated with reference to the drawings. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A moveable wiper assembly for cleaning an annular fluid filter comprising:
an integrally formed one piece member having
(a) a plurality of arcuately configured blades disposed in a spaced annular array with each of the blades having the radially outer surface configured for cleaning the filter;
(b) a plurality of spring members each having one reaction end thereof integrally formed with each of the arcuately configured blades and extending in a radially inward direction therefrom; and;
(c) an annular hub disposed centrally with respect to the annular array, the hub having a reaction end opposite the one reaction end of each spring formed integrally with the outer periphery of annular hub, wherein upon insertion of the wiper assembly in the annular fluid filter, each spring is operative to bias the respective blade radially outwardly, wherein the one piece member includes an open area for passage therethough of unfiltered fluid having an area of at least the area encircled by the inner periphery of the annular filter less the area of the elements of the one piece member.

2. The wiper assembly of claim 1, wherein each spring has one of (i) a curved configuration and (ii) a non-linear configuration in a radial direction.

3. The wiper assembly of claim 1, wherein each of the springs has the one reaction end disposed arcuately centrally on the blade.

4. The wiper assembly of claim 1, wherein the plurality of blades, springs, and hub are integrally formed as one piece from polymeric material.

5. The wiper assembly of claim 4, wherein the blades, springs, and hub are integrally molded of one of (i) polyoxymethylene, (ii) polyacetal and (iii) polyformaldehyde material.

6. A method of making a wiper assembly for cleaning an annular fluid filter comprising:
(a) forming an annular hub of polymeric material;
(b) integrally forming with the hub a plurality of radially outwardly extending circumferentially extending spring;
(c) integrally forming an arcuately configured blade at a radially outward end of each spring; and
(d) forming the blades in an annular array.

7. The method of claim 6, further comprising molding the hub, springs, and blades integrally of polymeric material.

8. The method of claim 7, further comprising molding of one of (i) polyoxymethylene, (ii) polyacetal and (iii) polyformaldehyde material.

9. A fluid filter assembly comprising:
(a) a pressure vessel with a removable closure forming an inlet chamber having a fluid inlet for receiving fluid to be filtered in the inlet chamber, a filtrate outlet; and a selectively openable drain outlet;
(b) an annular filter disposed in the pressure vessel with the inner upstream side thereof communicating exclusively with the fluid inlet chamber and the outer downstream side communicating exclusively with the filtrate outlet;
(c) a wiper assembly moveably disposed for cleaning the inner upstream side of the annular filter when the drain outlet is opened, the wiper assembly being removable when the closure is removed, the wiper assembly comprising a one piece member having
(i) a plurality of spaced arcuately shaped blades disposed in an annular array,
(ii) a radially inwardly extending spring having one reaction end thereof formed integrally with each of the blades,
(iii) an annular hub centrally disposed with respect to the annular array having a reaction end opposite the one end of each spring formed integrally with the outer periphery of the annular hub, wherein each of the springs is operative to bias the respective arcuate blade into contact with the filter, and
(iv) an open area for passage therethough of unfiltered fluid having an area of at least the area encircled by the inner periphery of the annular filter less the area of the elements of the one piece wiper.

10. The assembly of claim 9, wherein the wiper assembly is integrally formed as one piece of one of (i) polyoxymethylene, (ii) polyacetal and (iii) polyformaldehyde.

11. The assembly of claim 9, wherein each of the springs has one of (i) a curved configuration and (ii) a non-linear configuration in the radial direction.

12. The assembly of claim 9, further comprising a linear actuator connected to the wiper assembly and operative upon selective actuation to effect movement thereof for wiping contaminants from the filter media.
